(19) United States
(12) Patent Application Publication
(10) Pub. No.: US 2010/0293703 A1
(43) Pub. Date: Nov. 25, 2010

(54) GARMENT WITH BUILT-IN PROTECTING PADS

(76) Inventors: Celine Tezartes-Strauss, Tel Aviv-Yafo (IL); Efrayim Cohen, Herzelia (IL)

Correspondence Address: ARENT FOX LLP, 1050 CONNECTICUT AVENUE, N.W., SUITE 400, WASHINGTON, DC, 20036, US

(21) Appl. No.: 12/602,445

(22) PCT Filed: May 29, 2008
(86) PCT No.: PCT/IL2008/000726

§ 371 Date: Aug. 5, 2010

Related U.S. Application Data
(60) Provisional application No. 60/940,471, filed on May 29, 2007.
(60) Provisional application No. 61/049,024, filed on Apr. 30, 2008.

(51) Int. Cl. A41D 13/015; B05D 5/00

(52) U.S. Cl. 2/455; 427/288

(57) ABSTRACT

A garment having one or more built-in protective pads permanently or semi-permanently attached thereto, the pads being energy dissipating, conformable to the surface of the wearer body, durable and washable. The pads may include polyurethane or other similarly propertied cushioning material and may be permanently or semi-permanently fabricated into the garment fabric by applying or otherwise integrating the cushioning material to fabric, the fabric being any commonly used fabric. The cushioning material may be applied by molding, pouring or otherwise applying the material to the garment. The individual pads can vary in colors, rigidity, and other properties.

This application claims priority to Applicant's co-pending U.S. Provisional Patent Appl. No. 60/940,471 titled “GARMENT WITH BUILT-IN PROTECTING PADS” filed May 29, 2007, and to Applicant's co-pending U.S. Provisional Patent Appl. No. 61/049,024 titled “GARMENT WITH BUILT-IN PROTECTING PADS” filed Apr. 30, 2008, the entirety of each of which is hereby incorporated by reference herein.

### BACKGROUND

1. Field of the Invention

Aspects of the present invention relate to garments with protective pads and more particularly to garments having built-in protective pads permanently or semi-permanently attached thereto, the pads being energy dissipating, conformable to the surface of the wearer body, durable and washable.

2. Background of the Technology

There are several activities where users are facing inevitable impacts with other people and/or the ground and/or other obstacles. Such users often wear pads at or near certain locations of the body that are designed to absorb energy from sudden impacts, and thus to protect the user from incurring injuries that can be caused by the impact. Sudden impact occurs in activities such as professional and amateur sporting activities, military and law enforcement forces training, selected vocational activities and others. Sporting activities may include American football, soccer, hockey, baseball, rugby, cricket, basketball, skating, skiing, bicycle riding, motorcycle racing, and race car driving, among many others.

Most related art padding devices are worn over the garment or underneath the garment. FIG. 1 shows examples of related art protective pads, including American football shoulder pads 20, cricket batting leg guards 30, soccer player leg guards 40 and chest protecting devices 50 for sportswomen. FIG. 1 also shows a chest protecting device 60 for vocational wearers. U.S. Pat. No. 6,748,601, given to Lashoto et al, provides an articulating body protective vest for providing protection from impact based injuries to a user, utilizing removable pads. U.S. Pat. No. 7,100,216, given to Matechen et al, provides a garment that has a piece of clothing with at least one pad of conformable, energy dissipating media. In this patent, as well, the pads are removably attached to the garment with Velcro connectors, double sided tape, adhesive or sewn thereto.

There remains an unmet need for a protective pad that conforms to the body surface of the wearer in the area adjacent to where the pad is worn, and that dissipates the energy of a sudden impact to participants in sports or other activities. There is a further unmet need for a protective pad that is permanently or semi-permanently attachable to a user's garment for repeatable use, without the need to remove the pads for washing, for example, and without having to realign the pad at a location on to the garment, such as would be required when re-attaching the pad to the garment in the related art.

### SUMMARY OF THE INVENTION

Aspects of the present invention include features relating to and methods of manufacture of garments having built-in protective pads permanently or semi-permanently attached thereto, the pads being one or more of energy dissipating, conformable to the surface of the wearer body, durable, and washable. The pads in accordance with aspects of the present invention may comprise polyurethane based materials and may be permanently or semi-permanently fabricated into the garment fabric by applying the polyurethane based material onto fabric.

In accordance with aspects of the present invention, a garment having built-in protective pads permanently attached thereto is provided, the pads comprising polyurethane based materials. The polyurethane based material is typically molded or poured onto the garment in this exemplary application.

Aspects of the present invention include providing a protective pad that easily adapts to the body surface and that dissipates the energy of a sudden impact to participants in sports or other activities.

Aspects of the present invention include providing a protective pad that is comfortably wearable by the wearer.

Aspects of the present invention include providing a protective pad that is permanently or semi-permanently attached to the users garment for repeatable use, the pad not needing to be removed for washing, for example, and not having to be realigned in a pad location relative to the garment, as would be required if the pad were to be readily detachable from the garment.

Aspects of the present invention further include providing a protective pad capable of enduring multiple washing cycles and withstanding commonly used water temperatures and detergents, wherein the garment comprises any fabric commonly used for the designated activity of the garment.

The protective pads in accordance with aspects of the present invention may also include multiple layers of polyurethane, wherein two or more layers are optionally of different hardness and flexibility relative to one another.

Additional advantages and novel features relating to the present invention will be set forth in part in the description that follows, and in part will become more apparent to those skilled in the art upon examination of the following or upon learning by practice of aspects of the invention.

### BRIEF DESCRIPTION OF THE DRAWINGS

The present invention will become fully understood from the detailed description given herein below and the accompanying drawings, which are given by way of illustration and example only and thus not limitative of aspects of the present invention discussed here, and wherein:

FIG. 1 (prior art) shows examples of related art protective pads;

FIG. 2 depicts an example of a polyurethane pad molded onto a sock, in accordance with aspects of the present invention;

FIG. 3 depicts the inner side of the pad shown in FIG. 2;

FIG. 4 illustrates an exemplary garment having protective pads, in accordance with aspects of embodiments of the present invention, wherein the garment in this example is a shirt;

FIG. 5 illustrates part of an exemplary garment with a protective pad, in accordance with aspects of the present invention, wherein the part of a garment in this example is a sleeve of a shirt;

FIG. 6 illustrates an exemplary garment with protective pads, in accordance with aspects of the present invention, wherein the garment in this example is a pair of trousers;

FIG. 7 illustrates an exemplary garment with protective pads, in accordance with aspects of the present invention, wherein the garment in this example is a sock;

FIG. 8 illustrates the sock shown in FIG. 7, having a protective pad with two layers;

FIG. 9 illustrates an exemplary portion of a garment reinforced by a padded area including multiple protective pads, in accordance with aspects of the present invention;

FIG. 10 illustrates an exemplary portion of a garment with pads being poured onto the fabric, in accordance with aspects of the present invention;

FIG. 11 illustrates an exemplary portion of a garment with pads being poured onto the fabric and shaped by templates, in accordance with aspects of the present invention;

FIG. 12 illustrates an exemplary garment with multiple protective pads being poured onto various areas of the garment, in accordance with aspects of the present invention, wherein the garment in this example is a shirt; and

FIG. 13 illustrates an exemplary garment with multiple protective pads being poured onto various areas of the garment, in accordance with aspects of the present invention, wherein the garment in this example is a pair of trousers.

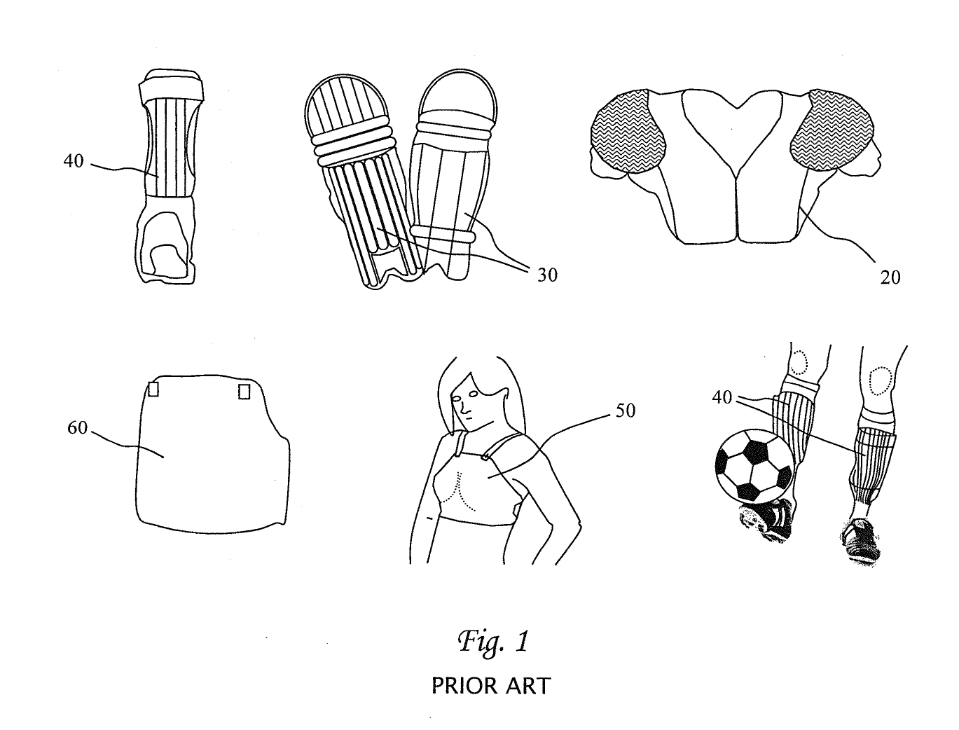

### DETAILED DESCRIPTION

Aspects of the present invention now will be described more fully hereinafter with reference to the accompanying drawings, in which variations and aspects of the present invention are shown. Aspects of the present invention may, however, be embodied in many different forms and should not be construed as limited to the variations set forth herein; rather, these variations are provided so that this disclosure will be thorough and complete, and will fully convey the scope thereof to those skilled in the art.

Unless otherwise defined, all technical and scientific terms used herein have the same meaning as commonly understood by one of ordinary skill in the art to which aspects of the present invention belong. The methods and examples provided herein are illustrative only and not intended to be limiting.

By way of introduction, aspects of the present invention include providing a garment having one or more built-in protective pads permanently or semi-permanently attached thereto, the pads being energy dissipating, conformable to the surface of the wearer body, durable and washable. The pads in accordance with some variations of the present invention comprise polyurethane or other polymer based materials, or other similarly propertied materials, hereinafter collectively and alternately referred to as “polyurethane materials” or “polyurethane based materials,” and are permanently or semi-permanently fabricated into garment fabric, the fabric being any commonly used fabric. In some variations, the polyurethane fills the porous fabric into which the pad is fabricated. The polyurethane based material is typically molded, poured, or otherwise applied onto a garment in one or more pads covering the garment area designated to be protective, such as when the material is in a heated, uncured state. The applied material is then cured, such as by cooling, prior to use.

### CERTAIN MATERIALS AND TERMS USED HEREIN

Polyurethane is any polymer comprising a chain of organic units joined by urethane links. Polyurethane is widely used in flexible and rigid foams, durable elastomers and high performance adhesives and sealants, fibers, seals, gaskets, condoms, carpet underlay, and hard plastic parts.

One main polyurethane producing reaction is between a diisocyanate (aromatic and aliphatic types are available) and a polyol, typically a polypropylene glycol or polyester polyol, in the presence of catalysts and materials for controlling the cell structure. Polyurethane can be made in a variety of densities and hardnesses by varying the type of monomer(s) used and/or adding other substances to modify characteristics, notably density, or enhance their performance. Other additives can be used to improve the fire performance, stability in difficult chemical environments and other properties of the polyurethane products. Polyurethane can be further mixed with other components to modify the end result material according to the application used. For example, colors can be added, materials may be added to form a glossy surface, etc.

Though the properties of the polyurethane may be determined mainly by the choice of polyol, the diisocyanate may exert some influence, and the amount thereof in the polyurethane can be suited to the application. The mechanical properties may be influenced by the functionality and the molecular shape. The choice of diisocyanate may also affect the stability of the polyurethane upon exposure to light. Polyurethanes comprise aromatic diisocyanates may yellow with exposure to light, whereas those made with aliphatic diisocyanates may be more stable when exposed to light.

Softer, elastic, and more flexible polyurethanes may result when linear polyethylene glycol segments, referred to herein as polyether polyols, are used to create the urethane links. More rigid products may result if polyfunctional polyols are used, as these substances can create a three-dimensional cross-linked structure, which can be in the form of low-density foam.

The following characteristics of polyurethane, among others, make it attractive to be used for pads designated to absorb sudden impacts:
Durometer: polyurethane comes in a variety of hardnesses. Durometer is the measure of the hardness of a particular material. Higher durometer grades can yield a very tough product with very high puncture resistance and very high abrasion resistance. Lower durometer grades can exhibit a very supple quality and feel very soft against human skin, making materials of these grades especially useful, for example, in the medical field, among other applications. Hence, pads can be designed with such characteristics to match the type of impact that is typically applied to the pad.
Elongation and Long-Term Durability: polyurethane has elongation capability, which enables it to withstand up to 700% or more elongation before breaking.
Memory: some forms of polyurethane also have excellent memory, meaning that these forms will return to their original dimensions after being stretched to their limits. Hence, pads having this characteristic can be reused and typically have longer useful lives than pads not having this characteristic.
Temperature Flexibility: polyurethane typically has excellent temperature flexibility, often making this substance a good material for demanding environments. Hence, pads of this material can typically be used and then washed at any commonly used washing temperature.
Tensile Strength: polyurethane can have tensile strength of up to 10,000 pounds per square inch (psi), which outperforms a multitude of other materials. Hence, pads of this material can typically sustain multiple high energy impacts.

It has been shown in the related art that polyurethane is highly durable and, moreover, has a capacity for shock absorption. An example usage of polyurethane foam is a high performance artificial turf called the DOW™ ENFORCER™, made by DOW® of Midland, Mich. Such application requires very high durability, and the shock absorption characteristics help reduce negative effects of impacts with the turf surface.

The term “garment,” as used herein, refers to any type of fabric, typically tailored to be wearable by a person, including, but not limited to: shirts, pants, socks, sleeves, hats, elastic bandages, belts, jackets, and skirts.

The term “energy dissipating” with respect to a protective pad, as used herein, refers to the ability of a protective pad to absorb the majority of the magnitude of a sudden hit/impact applied to the protective pad.

### Exemplary Variations

By way of example, with no limitation upon other materials, aspects of the present invention will be now described with regard to exemplary pads comprising polyurethane based materials, although pads in accordance with aspects of the present invention can comprise any other suitable material, such as material having similar high durability, tensile strength, temperature flexibility, designable flexibility, and designable durometer grade as polyurethane.

For the sake of clarity, some variations of the polyurethane pads of these illustrative examples are described as being fabricated onto the outer surface of a garments; however, such pads may similarly be fabricated onto the inner surface of the garment (nearer to the wearer body) and may also optionally be covered by another layer of fabric or any other material, for example.

The polyurethane pads in accordance with some variations of the present invention may be fabricated onto the fabric of a garment at a specific location and with a specific shape, the shape including a predesigned shape portion of the pad, at the rest state of the finalized pad, conforming with the typical shape of the surface of a part of the human body at the specific location. The shape of the pad can be pre-designed using particular molds or pouring the polyurethane into templates made of Aluminum, Perspex or other materials, for example, to which polyurethane does not stick.

The thickness, weight, flexibility and rigidity of any given pad usable in accordance with aspects of the present invention may depend, for example, on one or more of the following: a) the location on a garment at which the pad is destined to be integrated; b) the organ or other part of the human body for which the pad is designated to provide protection; and/or c) the activity for which the garment is designed. Furthermore, the thickness, flexibility and rigidity of a pad may be predetermined to match at least the expected energy of sudden impacts the pad is expected to endure. It should be noted that polyurethane is typically sealed to passage of liquids (such as water) and/or gasses (such as air). Therefore, when the polyurethane pad is relatively large or when protecting areas of the human body for which unobstructed or minimally obstructed airflow is important, the pad may be subdivided into several smaller pads, having gaps therebetween, so as to improve airflow in the padded region. The smaller pads of these variations can also improve the flexibility of the padded region and reduce the weight of the padded region.

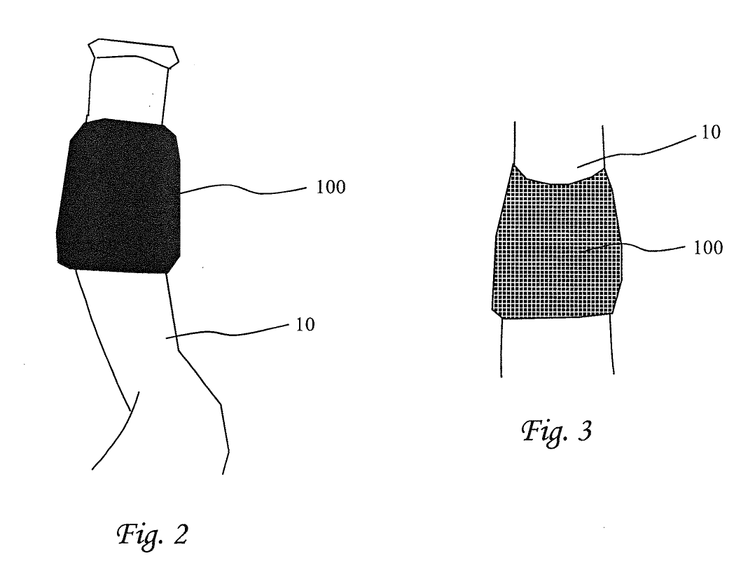

FIG. 2 depicts of a polyurethane pad 100 molded onto a garment 10, in accordance with aspects of the present invention. While in FIG. 2 the exemplary garment 10 is a sock, aspects of the present invention likewise apply to garment articles used in many different sports or other activities. Reference is also made to FIG. 3, which depicts the inner side of the polyurethane pad 100 shown in FIG. 2. The polyurethane fills the porous fabric of the sock 10, into which the pad 100 has been fabricated.

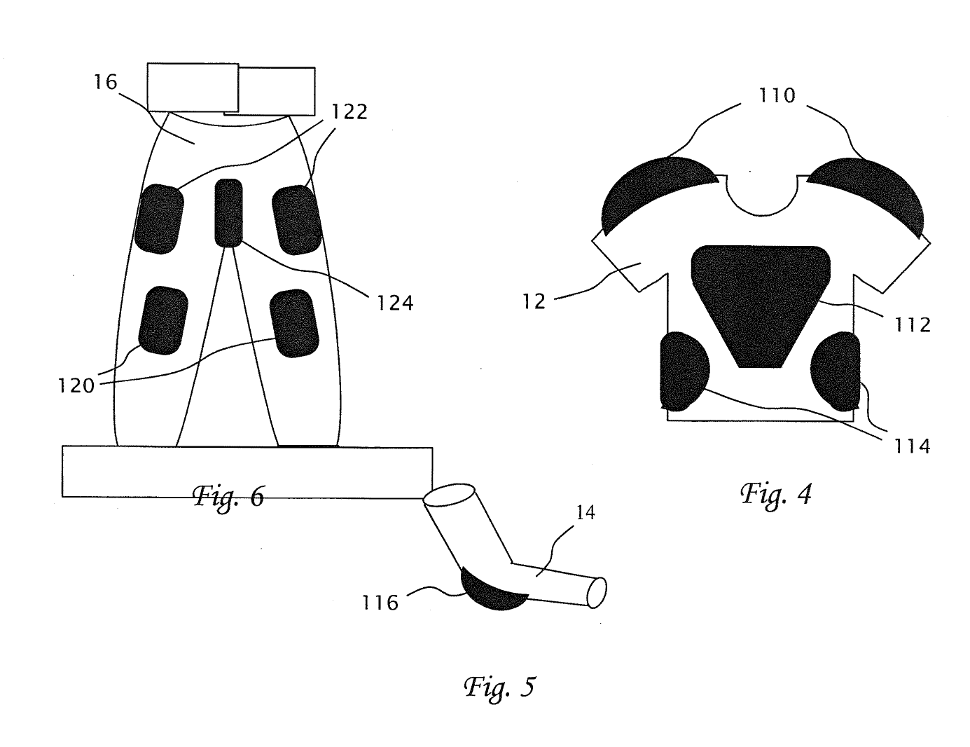

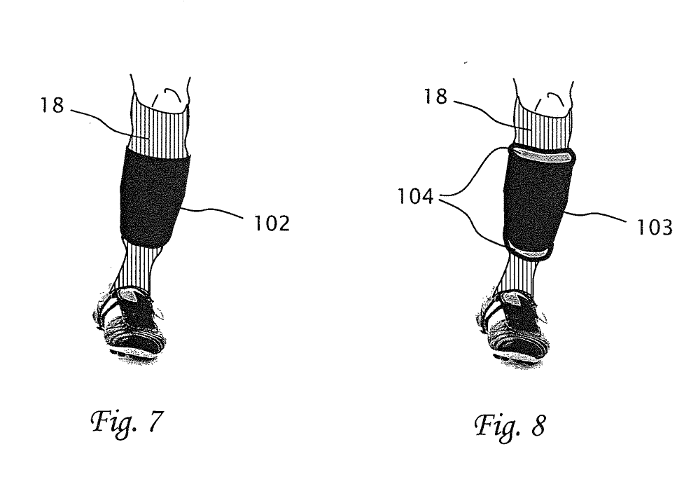

Reference also is made to FIG. 4, which illustrates another exemplary garment 10 having protective pads, in accordance with aspects of the present invention, wherein the garment in this example is a shirt 12. Reference is also made to FIG. 5, which illustrates a part of an exemplary garment, which in this example is a sleeve 14 of a shirt; to FIG. 6, wherein the exemplary garment in this example is a pair of trousers 16; and to FIG. 7, wherein the exemplary garment in this example is a sock 18.

The shirt 12 of FIG. 4 exemplifies shoulder protection pads 110, a chest protection pad 112 and kidney protection pads 114. But shirt 12 may have any set of protection pads positioned at any location to protect the wearer in the intended activity. Similarly, as shown in FIG. 5, sleeve 14 exemplifies an elbow pad 116 and sock 18 exemplifies a leg protection pad 102. Likewise, the trousers 16 of FIG. 6 exemplify thigh protection pads 122, a crotch protection pad 124 and knee protection pads 120. But the trousers 16 may have any suitable set of protection pads positioned at any appropriate location to protect the wearer in the intended activity.

Aspects of the present invention provide a protective pad that is comfortably worn by the wearer, wherein comfort is obtained by pads that are soft, flexible and/or having low weight. For example, many soccer players decline to wear their leg protective devices due to discomfort, and thus these players risk injury to their legs. Similarly, in accordance with some variations of the present invention, skiers may choose to wear hip, shoulder, thigh, knee and/or tail bone protective pads, which may not otherwise be suitable in the related art, due to the discomfort in wearing rigid protecting devices. Comfortable and yet efficient protective pads can similarly relieve American football players from some problems with the cumbersome shoulder pads and/or other pads of the related art that are typically worn.

Aspects of the present invention provide a protective padded region to protect an area of the human body for which unobstructed or minimally obstructed airflow is important. The pad may be subdivided into several smaller pads, having gaps therebetween, so as to improve airflow in the padded region. The smaller pads of these variations also improve the flexibility of the padded region. The smaller pads can have any individual shape, including but not limited to circular, semicircular, oval and semi-spherical. The smaller pads may be spaced apart in a fashion which allows for fabric flexibility, improved air flow, and improved shock absorption. The smaller pads may be spaced uniformly

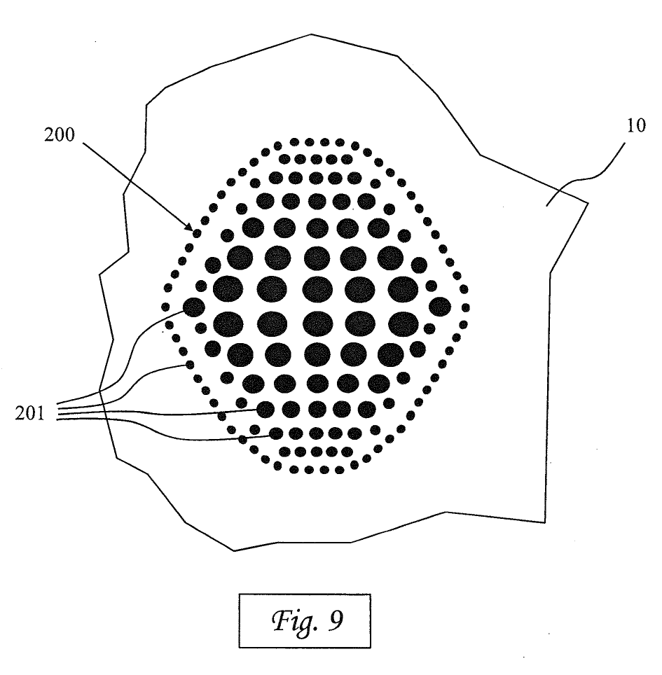

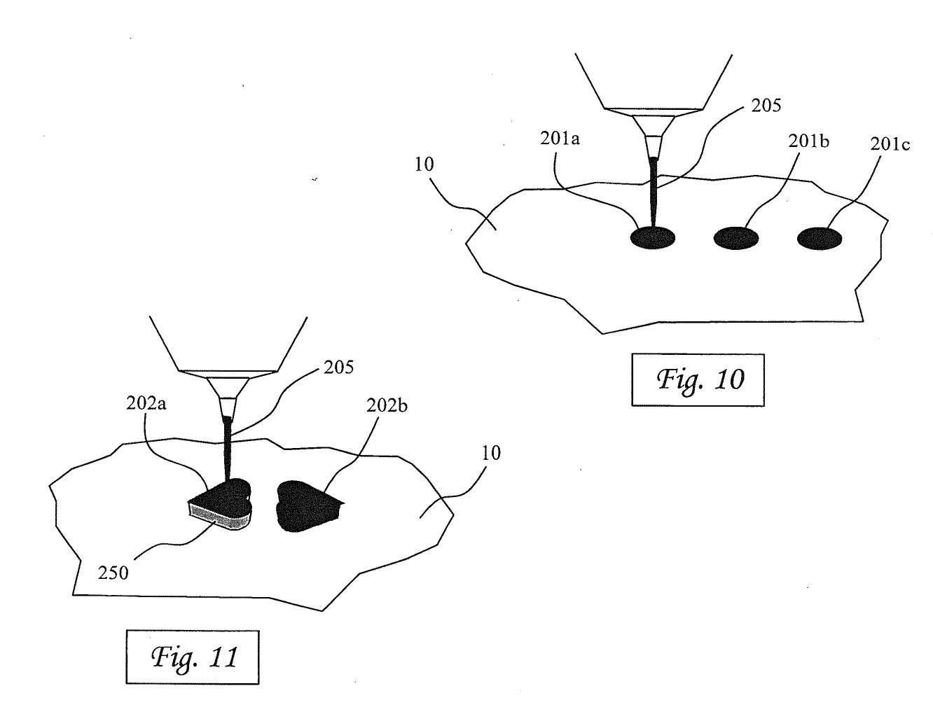

FIG. 9 illustrates an exemplary portion of garment 10 having reinforced padded region 200, which includes multiple protective pads 201, in accordance with aspects of the present invention. FIG. 10 illustrates an exemplary portion of garment 10 with pad 201a poured onto the fabric, in accordance with aspects of the present invention. Each individual pad 201 is formed by pouring material 205 onto the surface of the fabric of garment 10. FIG. 11 illustrates an exemplary portion of garment 10 with pads 202 being poured onto the fabric and shaped by templates 250, in accordance with aspects of the present invention. Padded regions 200 are more flexible than pads 100, covering the same region area, and don not obstructed airflow through the fabric as do pads 100.

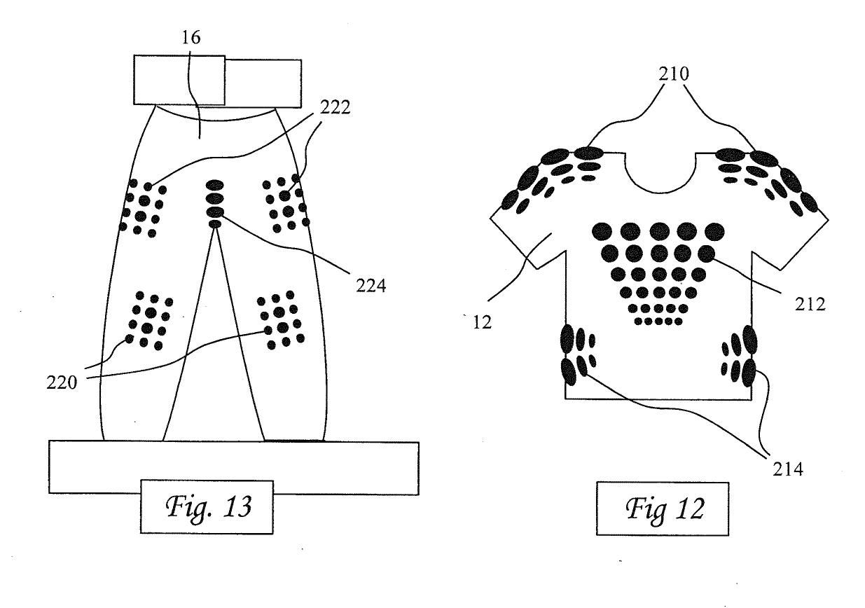

Reference also is made to FIG. 12, which illustrates another exemplary garment 10 having protective pads, in accordance with aspects of the present invention, wherein the garment in this example is a shirt 12 and to FIG. 13, wherein the exemplary garment in this example is a pair of trousers 16.

The shirt 12 of FIG. 12 exemplifies shoulder protection pads 210, a chest protection pad 212 and kidney protection pads 214. But shirt 12 may have any set of protection pads positioned at any location to protect the wearer in the intended activity. Similarly, the trousers 16 of FIG. 13 exemplify thigh protection pads 222, a crotch protection pad 224 and knee protection pads 220. But the trousers 16 may have any suitable set of protection pads positioned at any appropriate location to protect the wearer in the intended activity.

Other aspects of the present invention include providing at least one protective pad that is permanently or semi-permanently attachable to a garment for repeated, multiple uses, that does not need to have the pad removed for washing, for example, and that does not need to be realigned with respect to the garment, as may be necessary with related art pads that are detachable.

Aspects of the present invention further include providing at least one protective pad capable of enduring multiple washing cycles and withstanding commonly used water temperatures and detergents, wherein the garment is made from any fabric commonly used for the designated activity of the garment.

In some variations of the present invention, the protective pad includes multiple layers of polyurethane, wherein the layers may optionally have differing hardness and flexibility relative to one another. For example, a shoulder protecting pad for use in American football or a leg protecting pad for use in soccer may have a softer layer adjacent to the wearer body and a harder, shell portion layer on the external side of the pad, facing the environment. FIG. 8 illustrates sock 18 of a soccer player, having a protective pad with two layers (103 and 104). The harder layer prevents injury, while the softer layer cushions and dissipates any impact energy with respect to the wearer. In some variations of the present invention, the softer layer comprises pliable, softer characteristic polyurethane, and the harder layer comprises another rigid material or material otherwise having different characteristics, such as hard plastic or Carbon fiber. In some variations, one or more (e.g., the outer, shell portion layer) may have an applied or incorporated color.

In yet other variations of the present invention, the protective polyurethane pad includes other materials to enhance the protection properties according to the designated application, such as plastic layers or nets, rubber, fibers, and/or metal. Special powder may be added to make the pad bullet proof.

In other variations of the present invention, the protective polyurethane pads are also hydrophobic, repelling water and/or other fluids coming into contact with the pads.

Aspects of the present invention being thus described in terms of several variations and illustrative examples, it will be obvious that the same may be varied in many ways. Such variations are not to be regarded as a departure from the spirit and scope of the described aspects, and to incorporate such modifications as would be obvious to one skilled in the art.

1. A method for incorporating a protective pad into fabric of a garment for protecting a respective body area of a user wearing the garment, the method comprising:
a) selecting a region of said garment adjacent to said body area to be protected by said garment when worn;
b) applying an uncured cushioning material into said fabric of at least a portion of said selected region of said garment, wherein said cushioning material is poured onto said fabric by an injecting head, thereby forming at least a portion of said protective pad; and
c) curing said cushioning material, thereby permanently or semi-permanently integrating said protective pad into said fabric at said selected region, said protective pad being thereby energy dissipating for said respective protected body area.

2. The method of claim 1, wherein said cushioning material comprises a polymer based material, preferably, polyurethane based material.

3. (canceled)

4. The method of claim 1, wherein said cushioning material is applied to said fabric at said selected region in at least two layers.

5. (canceled)

6. The method of claim 4, wherein at least one of said layers of said cushioning material is molded into said fabric or onto another layer of said cushioning material.

7. (canceled)

8. (canceled)

9. The method of claim 1, wherein said protective pad is fabricated onto a surface of said garment selected from the group consisting of an outer surface of said garment and an inner surface of said garment.

10. The method of claim 1, wherein said protective pad is shaped by a template.

11. The method of claim 1, wherein said garment incorporating said protective pad is washable and preferably, facilitated to endure multiple washing cycles.

12. The method of claim 1, wherein said injecting head is controllably moved to form a desired shape of said protective pad.

13. A protective pad integrated into a fabric, manufactured in accordance with the method of claim 1.

14. A protective garment, comprising:
a) a fabric portion of said protective garment wearable onto a wearer's body, said fabric portion having a fabric region located proximal to an area of said wearer's body to be protected; and
b) a cushioning portion integrated into said fabric portion,
wherein said cushioning portion is integrated into said fabric region located proximal to said area of said wearer's body to be protected, in accordance with the method of claim

15. The protective garment of claim 14, wherein said cushioning portion comprises two or more layers.

16. The protective garment of claim 15, wherein at least one of said the two or more layers is a softer than other layers.

17. The protective garment of claim 15, wherein at least one of said two or more layers is a protective shell layer.

18. (canceled)

19. The protective garment of claim 14, wherein said cushioning portion comprises a polymer material, preferably, polyurethane based material.

20. (canceled)

21. The protective garment of claim 14, wherein said cushioning portion is permanently integrated into said fabric portion.

22. The protective garment of claim 14, wherein said cushioning portion is semi-permanently integrated into said fabric portion.

23. (canceled)

24. The protective garment of claim 14, wherein said cushioning portion is shaped to fit said area of said wearer's body to be protected.

25. (canceled)

26. (canceled)

27. (canceled)

28. (canceled)

29. The protective garment of claim 14, wherein said cushioning portion is made from fluid resistant materials such as water resistant materials.

30. (canceled)

31. The protective garment of claim 14, wherein said cushioning portion comprises two or more individual pads, thereby facilitating comfortable wearing of said protective garment and facilitating flow of air to and from said area of said wearer's body to be protected.

32. (canceled)

33. The protective garment of claim 31, wherein said two or more individual pads are uniformly spaced.
